(19) United States
(12) Patent Application Publication
(10) Pub. No.: US 2019/0279805 A1
(43) Pub. Date: Sep. 12, 2019

(54) AN INDUCTIVE DEVICE AND A MANUFACTURING METHOD

(71) Applicant: Höganäs AB (Publ), Höganäs (SE)

(72) Inventor: Fredrik AF EKSTRÖM, Helsingborg (SE)

(73) Assignee: Höganäs AB (Publ), Höganäs (SE)

(21) Appl. No.: 16/345,479

(22) PCT Filed: Oct. 27, 2017
(86) PCT No.: PCT/EP2017/077613

§ 371 Date: Apr. 26, 2019

(30) Foreign Application Priority Data
Oct. 28, 2016 (EP) 16196475.4

(51) Int. Cl. H01F 27/02; H01F 27/24; H01F 27/28; H01F 41/02

(52) U.S. Cl. CPC H01F 27/022; H01F 41/0246; H01F 27/28; H01F 27/24

(57) ABSTRACT

An inductive device and method for manufacturing an inductive device. The inductive device including: a magnetic core forming a void, the magnetic core including an outer and inner core portion, the magnetic core forming a first gap between a first part of the inner core portion a second part of the magnetic core, the first part of the inner core portion including an inner surface defining a first through hole; a sealing member accommodated at least partly in the first through hole, the sealing member including an outer surface forming a first seal with the inner surface defining the first through hole, such that at least a part of the first through hole is sealed from the first gap; a winding accommodated in the void of the magnetic core, the winding defining a first axial direction; and a cured material provided within at least a part of the first gap.

### TECHNICAL FIELD

The present disclosure relates to an inductive device, a sealing member, and a method for manufacturing an inductive device.

### BACKGROUND

Examples of inductive devices include transformers and inductors, sometimes also referred to as reactors or chokes.

Inductors are used in a wide array of applications such as signal processing, noise filtering, power generation, electrical transmission systems etc. In order to provide more compact and more efficient inductors, the electrically conducting winding of the inductor may be arranged around an elongated magnetically conducting core, also referred to as magnetic core.

Inductive devices are available in a large variety of designs and materials, each having their specific advantages and disadvantages. However, in view of the ever increasing demand for inductive devices in different applications there is still a need for inductive devices having a flexible and efficient design and which are usable in a wide range of applications.

Magnetic cores for inductive devices may be manufactured by pressing a soft magnetic powder material, e.g. an iron powder. The powder may be put into a cavity wherein the powder may be compacted.

Magnetic cores for inductive devices may be manufactured in a variety of designs. One design of magnetic cores, sometimes referred to as a pot core design, the magnetic core includes a base core portion from which an outer core portion and an inner core portion extend, e.g. in an axial direction. The inner core portion and the outer core portion define a void between them for accommodating the winding where the winding is arranged around the inner core portion. Inductive devices of this type provide a high degree of shielding against electromagnetic fields which otherwise may effect other electrical components in the vicinity of the inductor.

It remains desirable to provide improved inductive devices that allow an efficient manufacturing and assembly.

### SUMMARY

Disclosed herein are embodiments of an inductive device comprising: a magnetic core forming a void, the magnetic core comprising an outer core portion and an inner core portion, the magnetic core forming a first gap between a first part of the inner core portion and a second part of the magnetic core, the first part of the inner core portion comprising an inner surface defining a first through hole; a sealing member accommodated at least partly in the first through hole, the sealing member comprising an outer surface forming a first seal with the inner surface (i.e. the inner surface defining the first through hole), such that at least a part of the first through hole is sealed from the first gap; a winding accommodated in the void of the magnetic core, the winding defining a first axial direction; and a cured material provided within at least a part of the first gap. The cured material may fill the entire gap and/or the void of the magnetic core. The second part of the magnetic core may be a part of the inner core portion. The second part of the inner core portion may face the first part of the inner core portion.

Provision of the above-mentioned inductive device and in particular provision of the sealing member, may facilitate provision of the cured material within at least a part of the first gap, such as the entire first gap, and/or the void of the magnetic core, in a manner such that the cured material is prevented or at least impeded from entering the first through hole.

Embodiments of the inductive device may provide an inductive device in a cost-efficient and comparably simple manner.

The inductive device may be or comprise an inductor or a transformer or a similar device. An inductive device according to the present invention may throughout the present disclosure simply be denoted “inductor” or “inductive device”.

The winding typically comprises a plurality of turns. The turns define a central hole through which, during operation, the magnetic flux extends which is caused by electrical current through the turns of the winding. Thus, an axial direction may be defined by the turns of the winding as the direction of the magnetic flux through the center of the turns of the winding. The winding may be substantially cylindrical, although other geometries are possible as well.

The winding may be provided with lead wires extending from the winding. The lead wire may protrude from the void opening. The lead wire may be at least partly accommodated within the void opening. The lead wire may be configured to enable electrical connection, e.g. with an external part, such as an electrical device or circuit, e.g. via a respective wire.

The winding and the at least one lead wire (such as lead wires extending from both conductive ends of the winding) may be formed by a (such as one single) conductor (e.g. a wire, such as an at least partly isolated wire). Accordingly, part of a conductor may be formed into the winding with ends, i.e. lead wires, such as two lead wires, extending from the winding. Such conductor formed into a winding with extending lead wires may be isolated, e.g. by a coating of enamel or similar or another coating.

For the purpose of the present description the terms radial, axial, and circumferential are intended to refer to the respective directions of a cylindrical coordinate system defined relative to the axial direction defined by the winding, unless explicitly stated otherwise.

The void of the magnetic core may be defined as a volume, such as an at least partly enclosed volume, defined by the magnetic core and suitable for accommodating a winding.

The inductive device may comprise a plurality of windings. A second winding may be accommodated in the void of the magnetic core.

The magnetic core may form a plurality of void openings, such as a first void opening and a second void opening. Throughout the present disclosure, “the first void opening” may be referred to as “the void opening”. The second void opening may be arranged similar to the void opening, e.g. by having the cured material provided at least at a part of the second void opening; and having a second lead wire extending from the winding (or the second winding) and being partly embedded in and protruding from the cured material.

Providing the cured material at least at a part of the void opening may be understood as the cured material not necessarily being within the void opening, but close to, such as within 1 mm.

Throughout the present disclosure the term “void opening” may be understood as: “one or more void opening”. The void opening may be denoted “aperture”.

Throughout the present disclosure the term “lead wire” may be understood as: “one or more lead wire of the at least one lead wire, such as a first lead wire and/or a second lead wire”.

The first through hole of the first part of the inner core portion of the inductive device may facilitate mechanical connection of the inductive device to an external part. The first through hole may form part of a through hole of the inductive device.

In one or more embodiments the magnetic core is of the pot core type. Such core may provide a shielding effect, preventing or impeding radiation and reducing electromagnetic interference. A pot core may be provided by two halves, which may be identical, and which may fit together around the winding.

The magnetic core may comprise a base core portion from which an outer core portion and an inner core portion extend in the axial direction so as to form the void for accommodating the winding. A further base core portion may be provided at the opposite end of the inner and outer core portions. A base core portion may have a disc-like shape.

The void opening may be provided in the outer core portion.

In one or more embodiments, the inner core portion, the winding, and the outer core portion are arranged coaxially around the axial direction, with the inner core portion positioned radially most inward, successively surrounded by the winding, and the outer core portion.

The magnetic core may be formed by a plurality of core components such as at least two core components such as a first core component and a second core component. The first core component may comprise the base core portion and either: at least a part of the outer core portion or at least a part of the inner core portion or both. The second core component may comprise an end portion (e.g. the further base core portion) and complementary parts of the inner core portion and/or the outer core portion, such that the first and second core components, when assembled with each other, form the magnetic core. It will be appreciated that, in one or more embodiments, the first and second core components may be identical, thus forming two halves of the magnetic core (where the outer core portion may extend further from the base core portion in the axial direction than the inner core portion extends from the base core portion in the axial direction) while, in other embodiments, the first and second components may be different from each other. For example, in one or more embodiments, the first component may comprise the base core portion and the entire outer core portion and the entire inner core portion so as to form a receptacle for receiving the winding. In such an embodiment, the second core component may be formed as a lid for closing the open end of the first core component. In alternative embodiments, the first core component may comprise the base core portion and the entire outer core portion while the second core component comprises an end portion (i.e. e.g. a further base core portion) and the entire inner core portion. In yet another embodiment, the first core component may comprise the base core portion and the entire inner core portion while the second core component comprises an end portion (i.e. e.g. a further base core portion) and the entire outer core portion. It yet other embodiments the inner core portion and the outer core portion may be distributed between the first and second core components in a different manner. In one or more embodiments, one or more such as each magnetic core component forms a receptacle for receiving a part, e.g. one half, of the winding.

In one or more embodiments, the base core portion has an inner surface and an opposite, outer surface; wherein the inner core portion and the outer core portion axially extend from the inner surface. The outer core portion may at least partly surround the inner core portion, thereby forming the void around the inner core portion for accommodating the winding.

In one or more embodiments, the inner surface of the base core portion comprises a recess for accommodating at least a part of the lead wire. The recess may extend at least a part of a distance between the inner core portion and the outer core portion. The outer core portion may define the void opening, e.g. an aperture, which may be formed at least in part by a slit, extending from the end wall at the position of the recess. The outer core portion may be formed as a wall extending axially from the inner surface of the base core portion and having an end facing away from the inner surface. The aperture may be formed, at least in part, as a slit extending axially from said end to the inner surface. By virtue of the recess of the base core portion and the aperture, the lead wire of the winding may be conveniently arranged to extend through or to or close to the aperture and inside the recess without occupying any valuable winding space within the magnetic core. In one or more embodiments, the outer surface of the base core portion comprises an elevated area opposite to the recess. The elevated area opposite the recess may enable manufacture of a magnetic core including a recess and an aperture in a single pressing operation i.e. without requiring any aftermachining (such as a separate milling process). Furthermore, this may be achieved using a comparably simple press, e.g., without requiring any additional independently controllable punch. The elevated area adds to the second surface (i.e. the outer surface of the base core portion) at least some of the volume which is occupied by the recess, i.e. lost in the base core portion in order to form the recess, and thereby makes formation of the base core portion possible by reducing any biasing of the punch which otherwise may be caused by the presence of the recess. Consequently, the magnetic core may be manufactured in a cost and time efficient manner using a relatively simple press. In one or more embodiments, the end portion of the magnetic core opposite the base core portion may likewise comprise one or more recesses on its inner surface and, optionally, one or more corresponding protrusions on its, outer surface as described in connection with the base core portion.

According to one or more embodiments, a recess extends to an outer edge of the inner surface of the base core portion.

According to one or more embodiments the aperture extends to the recess such that the aperture joins the recess wherein the recess forms a periphery of the aperture.

According to one or more embodiments, the dimension of the outer core portion in the axial direction away from the inner surface of the base core portion exceeds the dimension of the inner core portion in the axial direction away from the inner surface.

In one or more embodiments, the magnetic core comprises two magnetic core components, each comprising the base core portion, an inner core portion and an outer core portion; wherein a rim of the outer core portion of the first magnetic core component engages with a corresponding rim of the outer core portion of the second magnetic core component, and wherein the respective inner core portions of the first and second magnetic core components together form an elongated inner core portion defining a gap, sometimes known as an air gap. In some applications it may be desirable to use a magnetic core including an air gap since a properly arranged air gap inter alia may reduce the inductance sensitivity to current variations.

The magnetic core may be made from and/or comprise a soft-magnetic composite powder material, which may be compressed for providing the magnetic core or components thereof. The powder material may be a ferrite powder, a high purity iron powder, a Fe—Si powder, other silicon-alloyed powders, an iron-phosphorous alloy or some other powder material with similar properties. Optionally, the material may be a soft magnetic composite powder material including a soft magnetic powder (e.g. iron) provided with an electrically insulating coating. Examples of composite materials that may be used are Somaloy 110i, Somaloy 130i, Somaloy 500, Somaloy 700 and Somaloy 1000 which may be obtained from Hoganas AB, S-263 83, Hoganas, Sweden. According to one or more embodiments, the compressed soft magnetic powder material includes at least 80% by weight of iron, such as at least 90% by weight of iron, such as at least 95% by weight of iron. An increased percentage of iron may improve the compressibility of the powder.

The magnetic core may have an extension in the axial direction of at least 1.5 mm (such as at least 4 mm) and/or less than 20 mm (such as less than 15 mm).

The magnetic core may have an extension in a second direction, perpendicular to the axial direction, of at least 3 mm (such as at least 8 mm) and/or less than 50 mm (such as less than 30 mm).

The thickness of the outer portion of the magnetic core, such as at a rim defining the void opening, may be at least 0.5 mm, such as at least 1 mm.

The inductive device may comprise a coil former, such as a bobbin, around which the winding may be provided. The coil former may be accommodated in the void of the magnetic core. The coil former may comprise one or more walls together defining a void for receiving the winding and separating at least a part of the winding from at least part of the magnetic core.

The void opening may be understood as the area or volume defined within the edges of the outer core portion outlining the void opening. The void opening may be understood as an area or volume missing in the outer core portion, such as a tubular wall part, such as a wall part of the same thickness as the wall thickness of the outer core portion.

The cured material may be provided within at least a part of the void opening. This may strengthen the mechanical coupling of the magnetic core and/or the inductive device as such. The cured material may fill the void opening. This may further strengthen the mechanical coupling of the magnetic core and/or the inductive device as such. The cured material may provided within and/or fill the void (i.e. the parts of the void not occupied by another element, such as the winding, the at least one lead wire, etc.) and may be connected to the cured material at the void opening. This may strengthen the mechanical coupling of the magnetic core and/or the inductive device as such. Furthermore, the stability of the winding with respect to the magnetic core may be strengthened.

The cured material may comprise or consist of any one or more of the following: {cured resin, cured epoxy, and cured polyurethane}. The cured material may be none magnetic conductive and/or none electric conductive.

In one or more embodiments, the inductor device comprises a flow channel defining an inlet port for inserting a curable material into the flow channel. The flow channel may define an outlet port opening into the void of the magnetic core, e.g. at a location opposite the void opening. Accordingly, the curable material may be provided to at least a part of the inductor device, such as at least initially by filling the void of the magnetic core.

The inductive device may be provided with one or more holes or channels providing a fluid conduit providing the flow channel to the void, so as to allow the curable material inserted into the inlet port of the flow channel to enter said void.

The flow channel may provide a connection from the inlet port to the winding accommodated in the void of the magnetic core. The method may comprise providing the curable material via the inlet port of the flow channel. The curable material may be provided under pressure, e.g. via the inlet port.

The filling may comprise inserting, optionally under pressure, a curable material into the inlet port of a flow channel formed by the inductive device.

In one or more embodiments the method comprises inserting a liquid, curable material into the inlet port when the assembled combination of magnetic core and winding is placed with the void opening formed in the outer core portion of the magnetic core facing upwards. The method may thus comprise letting the liquid curable material to flow through the flow path so as to fill the void. Hence, any space inside the inductive device which is left unoccupied by the winding (or any other device, such as a coil former) may be filled by the curable material from below in an efficient manner avoiding inclusions of gas.

The liquid, curable material may enter the void from below, and the level of curable material inside the magnetic core may rise gradually during the filling process, so as to fill any space inside the void that is left unoccupied by the winding. When the curable material reaches a desired level, e.g. at the void opening—e.g. at the rim of the aperture, the filling process may be stopped and the curable material may be allowed to cure.

Hence, an efficient filling process of the space surrounding the winding is provided while the inductor may be kept compact and a reliable insulation between the winding and the magnetic core is provided.

According to one or more aspects of the present invention, the curable material may be provided at the void opening by entering via the void opening.

The first through hole of the inner core portion may extend in the axial direction. The second through hole of the inner core portion may extend in the axial direction.

The second part of the magnetic core (which second part of the magnetic core may be a part of the inner core portion) may comprise an inner surface defining a second hole. The sealing member may be accommodated partly in the first through hole and partly in the second hole. The second hole may be a second through hole. The outer surface of the sealing member may form a second seal with the inner surface (i.e. the inner surface defining the second through hole), such that at least a part of the second through hole is sealed from the first gap.

The sealing member may comprise an inner surface defining a hole. The hole of the sealing member may be a through hole providing communication between the first through hole and the second through hole. Accordingly, a through hole of the inductive device may be formed by the through hole of the sealing member in combination with the first and second through holes of the magnetic core.

The sealing member may comprise a first protrusion in the outer surface. The first protrusion may form an annular protrusion. The first protrusion may be provided at the first gap. A protrusion may prevent the sealing member from entering further than desired/designed into the first through hole during manufacture of the sealing member. Another advantage is that manufacture is facilitated/made simpler.

The sealing member may comprise at least one tapering end. A tapering end may facilitate insertion of the sealing member into the first through hole and/or the second hole/through hole.

The sealing member may comprise a cylindrical part. The cylindrical part of the sealing member may match the first through hole.

The sealing member may comprise a tubular part.

The sealing member may comprise and/or be made of thermoplastic or another material having properties that facilitate creating a tight seal with the magnetic core.

The sealing member may be wedged in the first through hole. This may provide an improved sealing between the sealing member and the inner surface of the first through hole and/or the inner surface of the second through hole.

The sealing member may have an elongate form extending in the first axial direction.

The largest outer circumference of the sealing member (such as at the first protrusion) taken perpendicular to the first axis (and/or along a longitudinal extension of the sealing member) may be larger than the smallest inner circumference of the first through hole of the magnetic core taken perpendicular to the first axis. Accordingly, the first protrusion may prevent the sealing member from entering into the first through hole beyond the location of the largest outer circumference, such as at the first protrusion.

An outer circumference of the sealing member (i.e. at the area of the first seal) may match by compression the inner circumference of the first through hole (i.e. at the area of the first seal) in a tightly fit manner. The match may be such that if separated from each other, the outer circumference of the respective part of the sealing member will be at least slightly larger than the corresponding inner circumference of the respective part of the first through hole.

The sealing member may have an extension in the axial direction (and/or in the direction of the through holes of the inner core portion, within which the sealing member is situated, or is configured to be situated) exceeding the span of the gap of the magnetic core in the axial direction.

Provision of a through hole of the inductive device, such as defined at least in part by one or more though holes of the inner core part, may facilitate mounting of the inductive device.

The present disclosure relates to different aspects including the inductive device described above and in the following and to corresponding methods and/or products. Each aspect may yield one or more of the benefits and advantages described in connection with one or more of the other aspects, and each aspect may have one or more embodiments with all or just some of the features corresponding to the embodiments described in connection with one or more of the other aspects and/or disclosed in the appended claims.

According to a further aspect there is provided a sealing member configured for use in an inductive device as defined in the present disclosure.

Provision of a sealing member as disclosed in the present disclosure may enable use of identical sealing members for inductive devices having gaps of different lengths along the axial direction. This provides a cost effective provision of inductive devices according to the present invention having different dimensioned gaps.

According to a further aspect there is provided a method for manufacturing an inductive device, such as according to the present disclosure, the method comprising: providing a sealing member at least partly in a first through hole of a magnetic core, such that an outer surface of the sealing member forms a first seal with an inner surface of a first part of an inner core portion of the magnetic core, which inner surface defining a first through hole, such that at least part of the first through hole is sealed from a first gap defined by the magnetic core between the first part of the inner core portion and a second part of the magnetic core, the magnetic core comprising an outer core portion and the inner core portion; providing a winding in a void of the magnetic core; and providing a curable material within at least a part of the first gap. The curable material may be a liquid curable material, i.e. a liquefied version of the cured material. The curable material may cure to form the cured material.

Carrying out steps of providing the above-mentioned parts for manufacturing an inductive device may not be limited to being carried out in the above-mentioned order.

According one aspect, the winding is deemed to be accommodated in the void when at least part of the winding is accommodated in at least a part of the magnetic core defining at least a part of the void. According to another aspect, the winding is deemed to be accommodated in the void when the entire winding is accommodated in the entire magnetic core defining the entire void.

The method may comprise providing the second part of the magnetic core facing the first part of the magnetic core prior to providing the curable material.

The sealing member may be provided within part of the first through hole before or after providing the winding in the part of the void defined by the part of the magnetic core comprising the first part of the inner core portion.

The sealing member may be provided within part of the second hole/through hole during assembly of the first part of the magnetic core with the second part of the magnetic core.

The void opening may face upwards during provision of the curable material.

Provision of the curable material may comprise provision of the curable material to the void of the magnetic core, such that the winding being embedded in the curable material.

Provision of the curable material may comprise provision of the curable material within the opening of the magnetic core, such as by filling the opening.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, where like reference numerals will be used for like elements.

FIG. 1 is a perspective view schematically illustrating an embodiment of an inductor according to the present invention.

FIGS. 2A and 2B are perspective views schematically illustrating an example of an inductor core.

FIG. 3 is a top view schematically illustrating an inductor core of the inductor illustrated in FIG. 1.

FIG. 4 schematically illustrates an exploded view of the inductor illustrated in FIG. 1 without the cured material and with the sealing member shown displaced from an exploded position.

FIG. 5 schematically illustrates a perspective view of a section of the device of FIG. 1 during manufacture thereof.

FIG. 6 schematically illustrates a cross sectional side view of the inductor of FIG. 1 seen along the axial direction and intersecting the void opening.

FIG. 7 schematically illustrates a perspective view of the sealing member.

FIG. 8 schematically illustrates a side view of the sealing member.

FIG. 9 schematically illustrates a cross-sectional side view of the sealing member.

### DETAILED DESCRIPTION

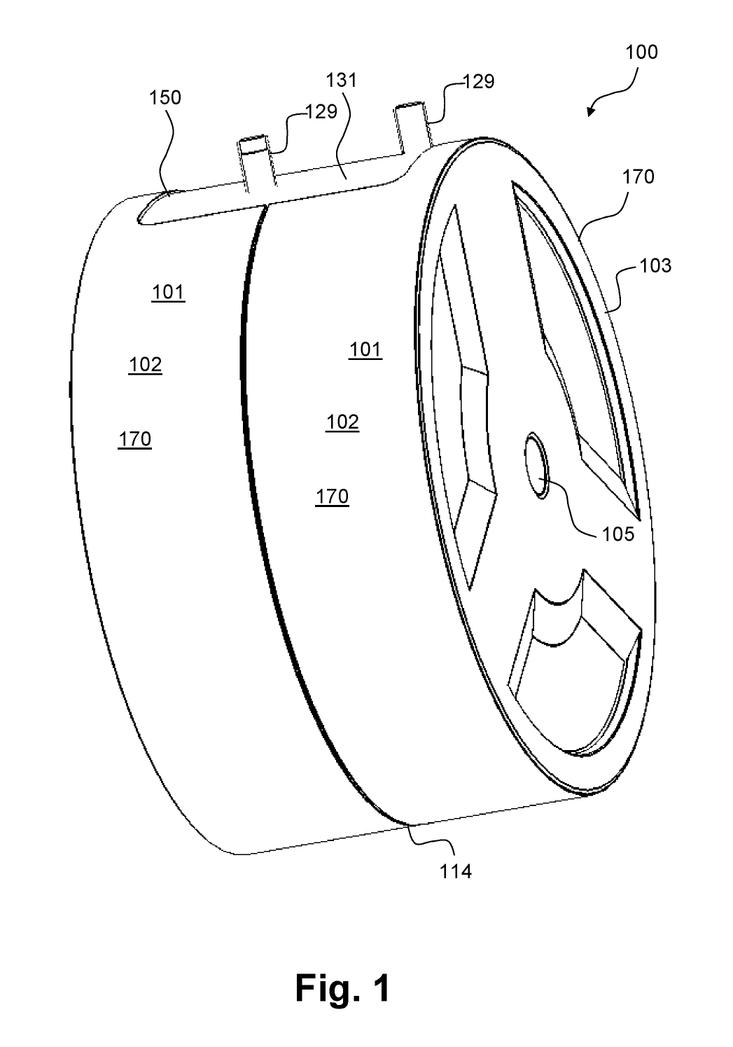

FIG. 1 schematically illustrate an assembled inductor (inductive device) 100 according to the present invention.

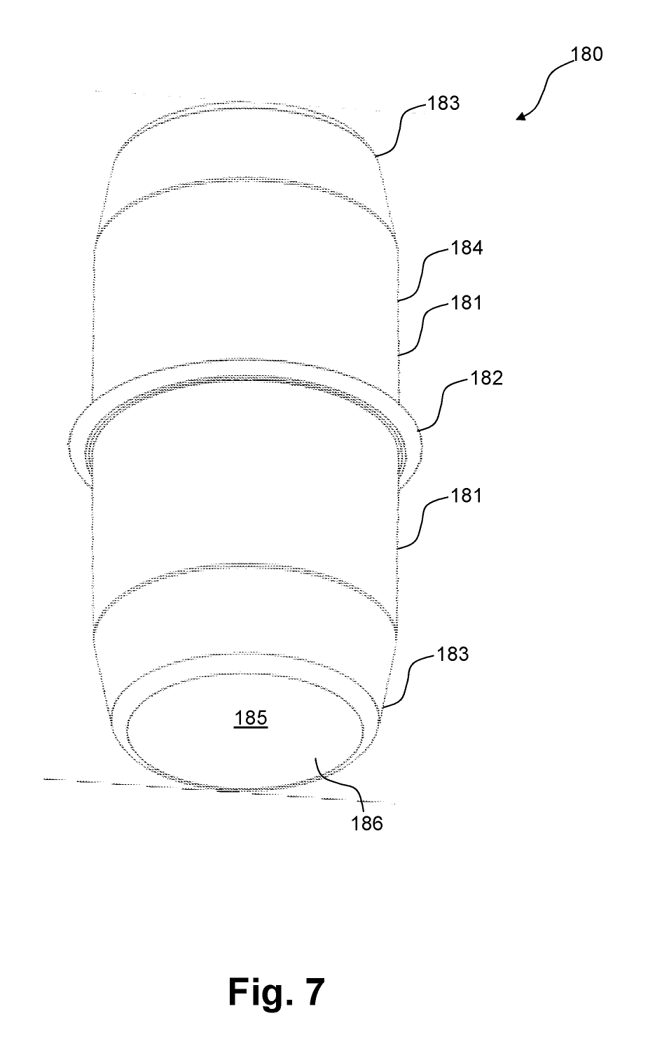

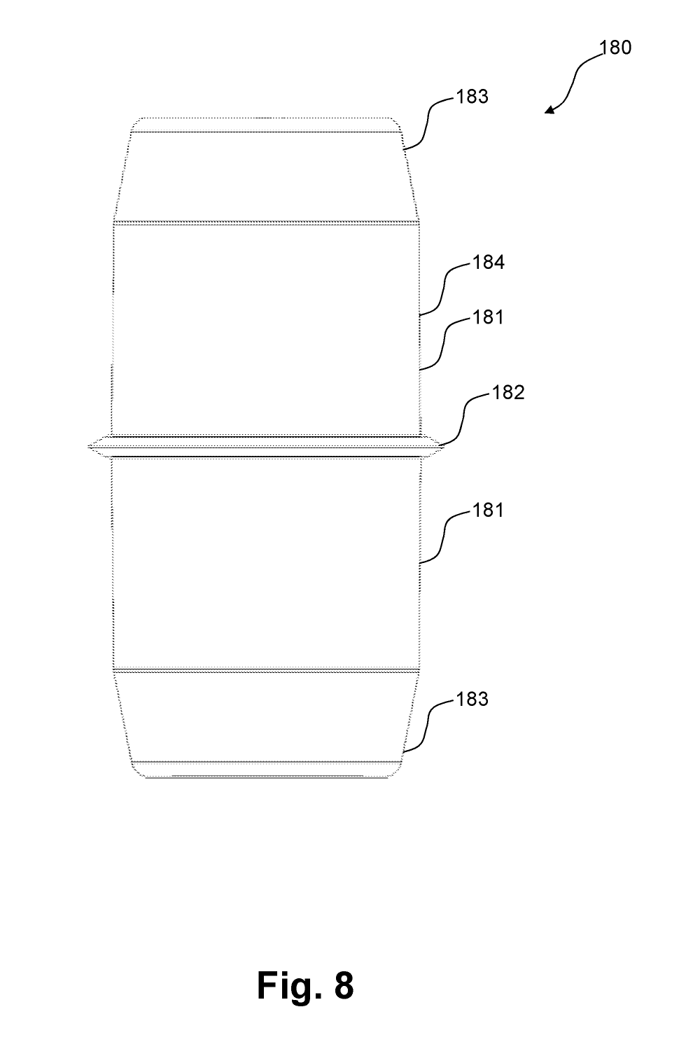

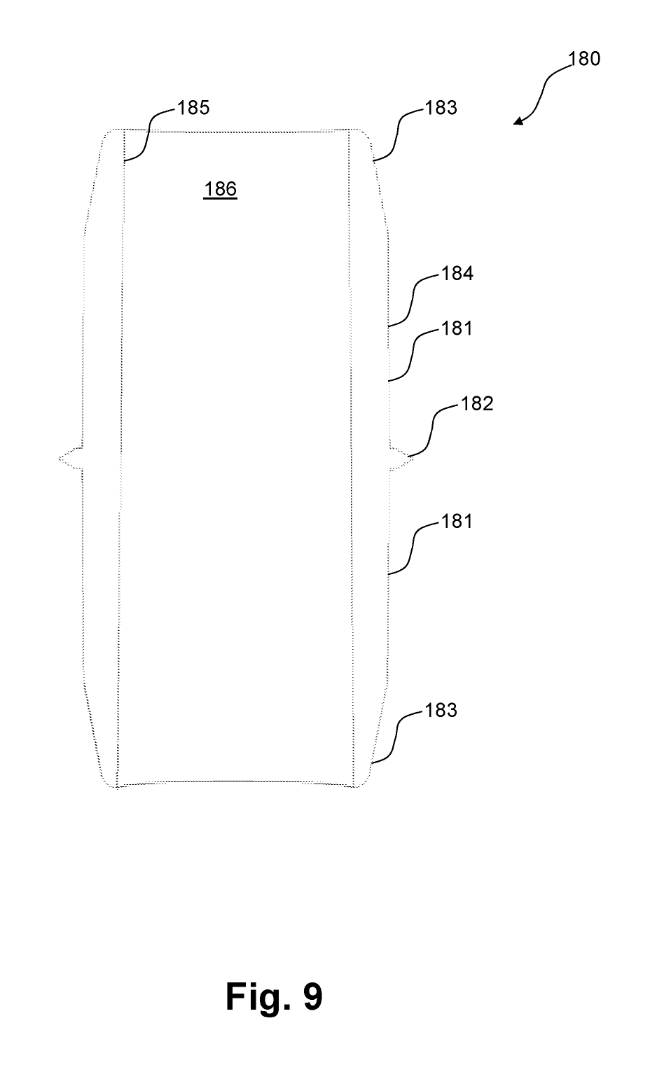

With reference in particular to FIGS. 1, 4, and 6, is illustrated the inductive device 100 comprising: a magnetic core 170 forming a void 160, the magnetic core 170 comprising an outer core portion 102 and an inner core portion 218, the magnetic core forming a first gap 190 between a first part 191 of the inner core portion 218 and a second part 192 of the magnetic core 170 (which second part 192 forming part of the inner core portion 218), the first part 191 of the inner core portion 218 comprising an inner surface 193 defining a first through hole 194; a sealing member 180 accommodated at least partly in the first through hole 194, the sealing member 180 (which is illustrated in greater detail in FIGS. 7-9, to which reference is made) comprising an outer surface 181 forming a first seal 197 with the inner surface 193 defining the first through hole 194, such that at least a part of the first through hole 194 is sealed from the first gap 190; a winding 111 accommodated in the void 160 of the magnetic core 170, the winding 111 defining a first axial direction; and a cured material 131 provided within at least a part of the first gap 190.

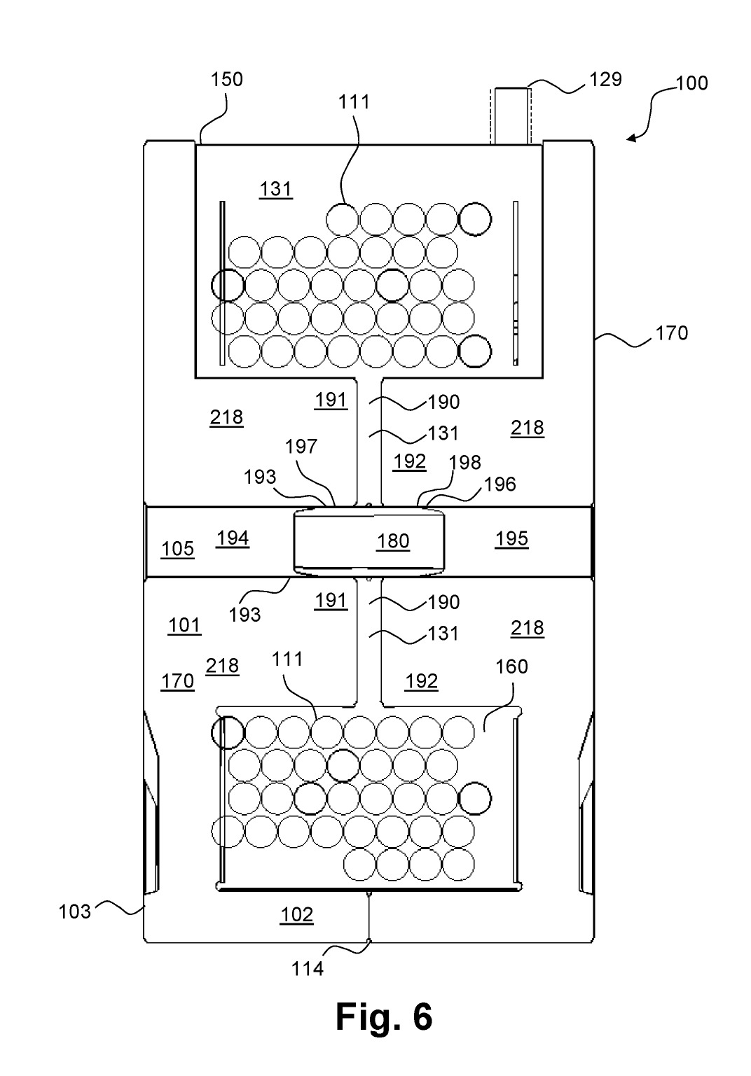

As illustrated by means of FIGS. 1 and 6, the cured material 131 fills substantially the entire first gap 190, void 160 and an opening 150 of the magnetic core 170.

With reference to FIG. 6 in combination with FIGS. 7-9, the sealing member 180 comprises a first protrusion 182 in the outer surface 181. The first protrusion 182 forms an annular protrusion. The first protrusion 182 is provided at the first gap 190. The sealing member 180 comprises at least one tapering end 183 including two tapering ends 183. The sealing member comprises a cylindrical part 184 forming part of the outer surface 181. The sealing member comprises a tubular part and in generally tubular. The sealing member is made of thermoplastic. The sealing member comprises an inner surface 185 defining a hole 186. The hole 186 of the sealing member is a through hole. The sealing member has an elongate form extending in the first axial direction.

The second part 192 of the magnetic core 170 comprises an inner surface 196 defining a second hole 195. The sealing member is accommodated partly in the first through hole 194 and partly in the second hole 195. The second hole 195 is a second through hole 195. The outer surface 181 of the sealing member forms a second seal 198 with the inner surface 196 defining the second through hole 195. Accordingly, at least a part of the second through hole 195 is sealed from the first gap 190.

The through hole 186 of the sealing member 180 provides communication between the first through hole 194 and the second through hole 195.

The sealing member 180 is wedged in the first through hole 194. The sealing member 180 is wedged in the second through hole 195.

The magnetic core 170 forms a void opening 150.

The inductive device 100 comprises at least one lead wire 129 (including two lead wires 129) extending from the winding 111. The at least one lead wire 129 is partly embedded in and protrudes from the cured material 131.

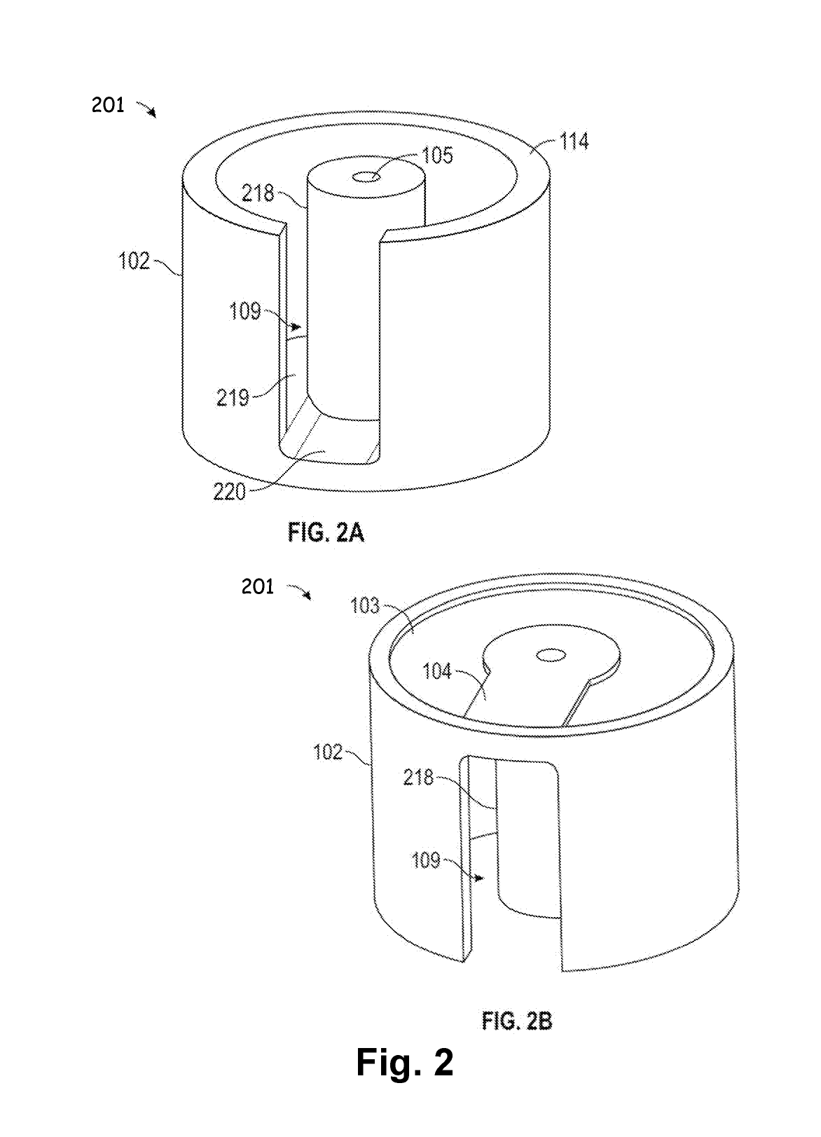

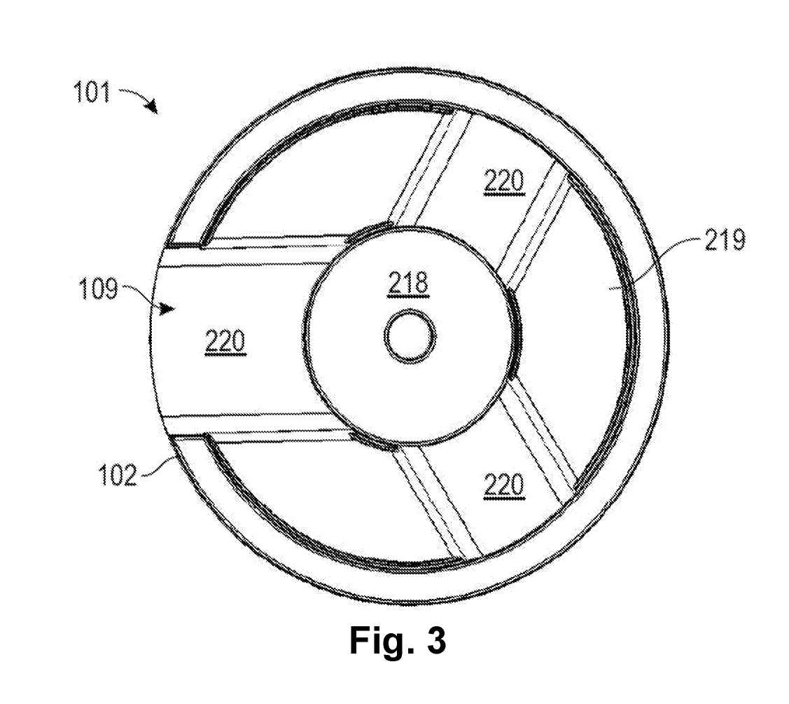

The magnetic core 170 is of the pot core type and is formed by two identical magnetic core components 101, examples of which are described further in connection with FIGS. 2A, 2B, and 3.

FIGS. 2A and 2B are perspective views illustrating an example of a magnetic core component 201 for an inductor, e.g. one or both of the magnetic core components 101 that form the magnetic core 170 of the inductor 100 of FIG. 1.

FIG. 3 is a top view illustration (i.e. a view into the open end of the magnetic core component) of one or both of the magnetic core components 101 of the inductor 100 of FIG. 1. The magnetic core component 101 is similar to the magnetic core component 201 of FIGS. 2A and 2B, but it differs in that it includes more than one recess 220.

Each component 101, 201 is formed as a pot-shaped component (or a half or a part thereof) comprising a base core portion 103, an inner core portion 218 and an outer core portion 102 forming a circumferential wall. Each magnetic core component 101, 201 thus has a closed end formed by the base portion 103 and an opposite open end delimited by a rim or end surface 114 of the outer core portion. The magnetic core components are assembled with the rims of their respective outer core portions facing each other. The end faces may abut each other or otherwise engage each other or be connected with each other.

The magnetic core component 101, 201 may be made of a compressed soft magnetic powder material and it comprises a disc-shaped base core portion 103. The base core portion 103 includes an inner surface 219 and an outer surface, opposite the inner surface. The inner core portion 218 extends perpendicularly from the inner surface 219 in the axial direction. The inner core portion 218 has an annular cross section. The outer core portion 102 is provided in the form of a tubular wall which extends in the axial direction from the inner surface 219 and whose opposite end defines the rim 114 of the outer core portion 102.

The inner core portion 218 extends from a center part of the base core portion 103 while the outer core portion 102 extends from a radially outermost periphery of the base core portion 103. When a magnetic core 170 is assembled from two magnetic core components 101, 201, the outer core portions 102 together form a circumferential housing (which defines the void 160) of the magnetic core 170. The magnetic core 170 thus provides a magnetic flux path axially along the inner core portion, radially inward/outward through the disc-shape base core portions and a return path axially along the outer core portion.

The inner core portion 218 may be provided with an axially extending hole 105. The hole may be a through-hole. The hole may be arranged to receive fastening means, such as a bolt or the like, for attaching the inductor core 170 to an outer structure.

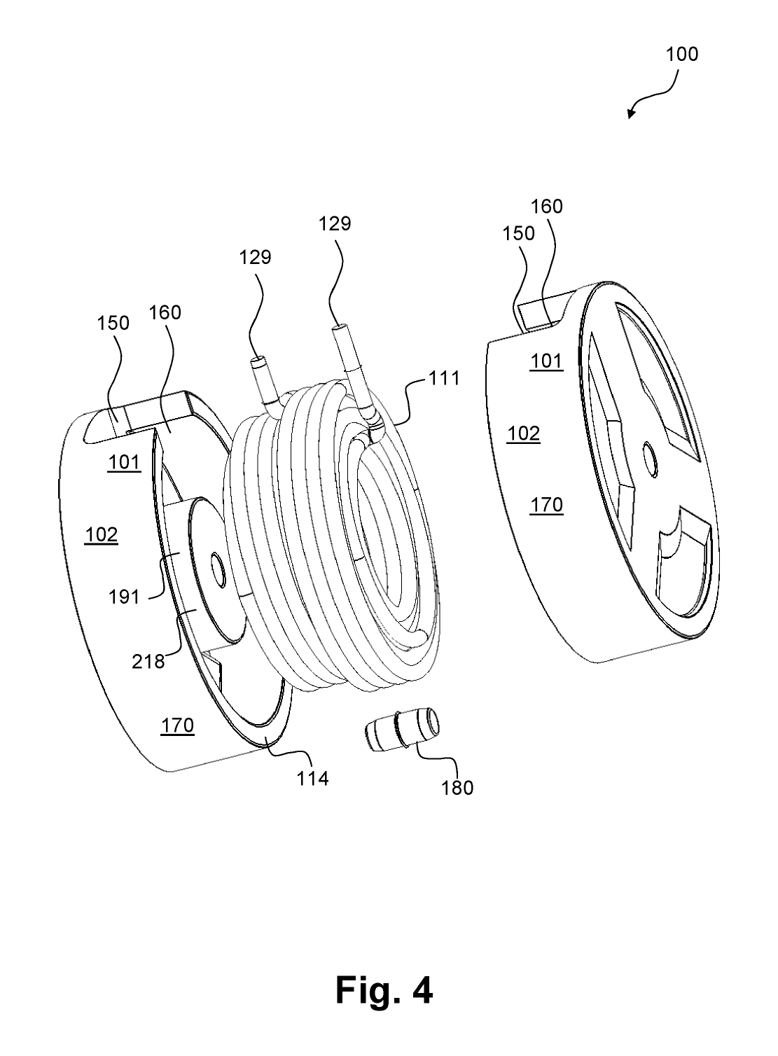

The outer core portion 102 at least partly surrounds and is arranged coaxially with the inner core portion 218. Thereby, an annular void 160 extending radially and axially between the inner core portion 218 and the outer core portion 102 is formed. In this space, a winding 111 (as illustrated in FIGS. 4-6 and 8-10) may be accommodated.

The outer core portion 102 includes a slit 109. The slit 109 extends from the rim 114 towards the inner surface 219 of the base core portion 103. The slit 109 extends through the full radial thickness of the outer core portion 102. The wall portions of the outer core portion 102 defining the slit 109 extend along the axial direction. When assembled with another magnetic core component, the slit 109 defines at least part of the void opening 150.

The inner surface 219 includes a recess 220 extending in the radial direction from the inner core portion 218 towards the slit 109, thereby joining the slit 109, wherein the recess 220 forms the bottom of the slit 109. At the radial position where the recess 220 joins the slit 109, the recess 220 and the slit 109 have approximately equal widths, i.e. equal circumferential dimensions.

The recess 220 is arranged to accommodate one or more connecting leads (i.e. lead wire 129) of one or more windings arranged around the inner core portion 218. In particular, a lead wire 129 (see FIGS. 4-6 and 8-10) from the inner turn of the winding 111 (see FIGS. 4-6 and 8-10) may extend radially outwards in the recess 220 and through the slit 109. The slit 109 is arranged to provide a lead-through for a lead wire. Lead wires of one or more windings may thus be arranged through the slit 109 and along the recess 220 of the base core portion 103 towards the inner core portion 218 while occupying a minimum volume of the winding space.

The outer surface of the base core portion 103 comprises a protrusion 104. The protrusion 104 protrudes in the axial direction. The protrusion 104 extends in a radial direction from a central part of the outer surface towards an outer radial edge of the outer surface. The protrusion 104 is coextensive with the recess 220 by extending along, and in parallel with the recess 220.

The inner surface 219 of the base core portion of the magnetic core component 101 of FIG. 3 includes three recesses 220. The recesses are symmetrically distributed on the inner surface with respect to an angular direction such that an angle of approximately 120° is formed between adjacent pairs of recesses. However other distributions are also possible. The outer core portion 102 comprises a slit 109 which extends from the rim of the outer core portion towards one of the recesses 220 which recess thus forms the bottom of the slit 109.

It should be noted that a magnetic core component may include a different number of recesses than one or three as described above. For example, a magnetic core component may include two recesses and two corresponding protrusions. In that case, the two recesses (and the two protrusions) may be arranged at an angle of 180° in relation to each other.

In the magnetic core components described above, one of the recesses 220 extends from the inner core portion 218 to the slit 109. According to an alternative embodiment, the radially innermost part of the recess 220 may be separated from the inner core portion 218 by a distance, i.e. a non-zero distance. This may be useful, for example, when using a multi-layer winding having a thickness such that the outer layer of the winding roughly coincides with the innermost radial part of the recess 220 wherein the connection portion of the winding which is to be accommodated in the recess leaves the winding at the innermost radial part of the recess 220.

The outer core portion 102 extends further from the base core portion 103 in the axial direction than the inner core portion 218 extends from the base core portion 103 in the axial direction. Accordingly, when two identical components 101, 201 are assembled, the first gap 190 is formed.

Going back to FIGS. 1, 4, and 6, the lead wires 129 protrude from the void opening 150. Furthermore, the lead wires 129 are at least partly accommodated within the void opening 150. The void opening 150 is defined by the outer core portion 102. The lead wires 129 are shown as just protruding the void opening 150. However, the lead wires 129 may extend at any length from the void opening 150.

Different views of the sealing member are better seen in FIGS. 7-9.

The cured material 131 is provided within at least a part of the void opening 150. As illustrated in FIGS. 1 and 7-9, the cured material 131 is provided within substantially the entire void opening 150. As illustrated in FIGS. 7-9, the cured material 131 is provided within substantially the entire void 160 not occupied by any other part, like the winding 111 and the lead wires 129.

The cured material 131 (illustrated in FIGS. 1 and 6) has been left out for illustrative purposes in FIG. 4.

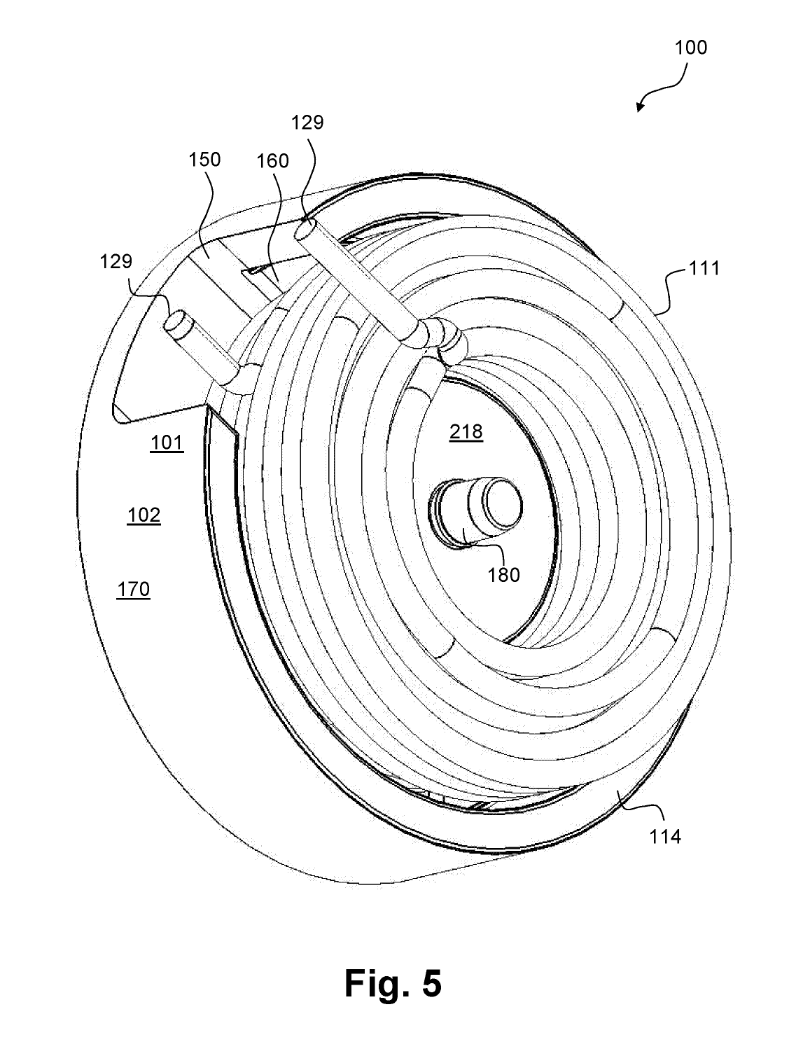

FIG. 5 schematically illustrates a perspective view of a section of the device of FIG. 1 during manufacture of the device, i.e. the winding 111 is accommodated in the void 160 (i.e. a part thereof) and the sealing member 180 is accommodated within a part of the first through hole (not visible in FIG. 5). Subsequently, the second core portion 101 (see e.g. FIG. 4) will be assembled with the first core portion 101 illustrated in FIG. 5, such that the protruding part of the sealing member enters the through hole of the second core portion (as illustrated and explained in connection with FIG. 6). Subsequently, curable material is provided to the first gap and possibly also to the core.

Although one or more embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention. For example, although an inductive device having circular cross sections has been described in the above, the inventive concept is not limited to this specific shape. For example, the magnetic core may present a section of a circular cross section, an elliptical cross section, a rectangular cross-section, a polygonal cross section etc. without departing from scope of the present inventive concept, as defined in the independent claims.

In device claims enumerating several features, several of these features can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in the present disclosure is taken to specify the presence of stated features, integers, steps or components but does not preclude the presence or addition of one or more other features, integers, steps, components or groups thereof.

1. An inductive device comprising:
a magnetic core forming a void, the magnetic core comprising an outer core portion and an inner core portion, the magnetic core forming a first gap between a first part of the inner core portion and a second part of the magnetic core, the first part of the inner core portion comprising an inner surface defining a first through hole;
a sealing member accommodated at least partly in the first through hole, the sealing member comprising an outer surface forming a first seal with the inner surface defining the first through hole, such that at least a part of the first through hole is sealed from the first gap;
a winding accommodated in the void of the magnetic core, the winding defining a first axial direction; and
a cured material provided within at least a part of the first gap.

2. The inductive device according to claim 1, wherein the sealing member comprises a first protrusion in the outer surface.

3. The inductive device according to claim 2, wherein the first protrusion forms an annular protrusion.

4. The inductive device according to claim 2, wherein the first protrusion is provided at the first gap.

5. The inductive device according to claim 1, wherein the sealing member comprises at least one tapering end.

6. The inductive device according to claim 1, wherein the sealing member comprises a cylindrical part.

7. The inductive device according to claim 1, wherein the sealing member comprises a tubular part.

8. The inductive device according to claim 1, wherein the sealing member comprises thermoplastic.

9. The inductive device according to claim 1, wherein the sealing member is wedged in the first through hole.

10. The inductive device according to claim 1, wherein the sealing member having an elongate form extending in the first axial direction.

11. The inductive device according to claim 1, wherein the second part of the magnetic core comprising an inner surface defining a second hole, and wherein the sealing member being accommodated partly in the first through hole and partly in the second hole, and wherein the second hole being a second through hole, and wherein the outer surface of the sealing member forming a second seal with the inner surface defining the second through hole, such that at least a part of the second through hole is sealed from the first gap.

12. The inductive device according to claim 11, wherein the sealing member comprising an inner surface defining a hole.

13. The inductive device according to claim 12, wherein the hole of the sealing member being a through hole providing communication between the first through hole and the second through hole.

14. A sealing member configured for use in an inductive device as defined in claim 1.

15. A method for manufacturing an inductive device, the method comprising:
providing a sealing member at least partly in a first through hole of a magnetic core, such that an outer surface of the sealing member forms a first seal with an inner surface of a first part of an inner core portion of the magnetic core, which inner surface defining a first through hole, such that at least part of the first through hole is sealed from a first gap defined by the magnetic core between the first part of the inner core portion and a second part of the magnetic core, the magnetic core comprising an outer core portion and the inner core portion;
providing a winding in a void of the magnetic core; and
providing a curable material within at least a part of the first gap.
